(19) United States
(12) Patent Application Publication
(10) Pub. No.: US 2006/0265279 A1
(43) Pub. Date: Nov. 23, 2006

(54) On-line reporting and proof of performance system for advertising campaigns

(75) Inventors: Andrew E. Livingston, Los Angeles, CA (US); Lawrence Butler, Santa Monica, CA (US)

Correspondence Address: YING CHEN, 255 S. GRAND AVE., # 215, LOS ANGELES, CA, 90012, US

(73) Assignee: FreeCar Media, LLC

(21) Appl. No.: 11/134,010

(22) Filed: May 20, 2005

(51) Int. Cl. G06Q 30/00

(52) U.S. Cl. 705/14

(57) ABSTRACT

A reporting system is described which provides current information on the progress of advertising campaigns, consumer feedback on the brands or products being advertised, or details on sample and premium distribution. Individuals perform campaign activities on behalf of an advertiser, such as by driving vehicles that have been custom fitted to display advertisement information on their exterior about the brands or products, or by otherwise interacting with targets of the campaign. The on-line reporting system provides means for the individual drivers to upload reports about the individuals' advertising activities into a computer system in a timely fashion, such as on a daily basis. The reporting system also provides means for the advertiser to review the reports received from the individual drivers and evaluate the effectiveness of the campaigns. In a vehicle-based advertising campaign, real-time GPS tracking of vehicles may be provided and a measure of impression may be calculated based on the routs traveled by the vehicles.

### BACKGROUND OF THE INVENTION

This invention relates to an on-line reporting and proof of performance system and related methods, and in particular, it relates to such systems and methods used in marketing and advertising campaigns.

### SUMMARY OF THE INVENTION

Advertising methods have been known where individuals are engaged to perform advertising tasks. Such tasks may be performed on a mobile basis, and may include interactions between the individuals so engaged and the targets of the advertising campaign.

An object of the present invention is to provide a system that allows advertisers to obtain timely reports and feedback about an advertising campaign from individuals engaged to perform advertising tasks.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides an advertising method that includes providing advertisement information or resources to individuals engaged to perform advertising activities; providing a report tool for the individuals to submit activity reports of advertising activities via a computer network; and providing a review tool for advertisers to review the submitted activity reports via a computer network.

More specifically, the present invention provides an advertising method that includes providing custom-fitted vehicles to individual drivers, the vehicles having been custom fitted to display advertisement information on their exterior; providing a report tool for individual drivers to submit activity reports of advertising activities via a computer network; and providing a review tool for advertisers to review the submitted activity reports via a computer network.

The invention also provides an advertising method that included providing custom-fitted vehicles to individual drivers, the vehicles having been custom fitted to display advertisement information on their exterior, automatically obtaining information regarding the locations and travel routes of the vehicles, calculating impressions generated by each vehicle based on its locations and travel routes, providing a report tool for individual drivers to submit activity reports of advertising activities via a computer network, and providing a review tool for advertisers to review the submitted activity reports via a computer network.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an on-line reporting system according to an embodiment of the present invention.

FIG. 2 depicts a custom-fitted vehicle useful in an advertising method according to an embodiment of the present invention.

### DETAILED DESCRIPTION OF THE PREFERRED EMBODIMENTS

A reporting system is described which provides current information on the progress of advertising campaigns, consumer feedback on the brands or products being advertised, or details on sample and premium distribution. Individuals perform campaign activities on behalf of an advertiser, such as by driving vehicles that have been custom fitted to display advertisement information on their exterior about the brands or products, or by otherwise interacting with targets of the campaign. The on-line reporting system provides means for the individual drivers to upload reports about the individuals; advertising activities into a computer system in a timely fashion, such as on a daily basis. The reporting system also provides means for the advertiser to review the reports received from the individual drivers and evaluate the effectiveness of the campaigns. In a vehicle-based advertising campaign, real-time tracking of vehicles using the Global Positioning System (GPS) may be provided and a measure of impression may be calculated based on the routs traveled by the vehicles.

An advertising method has been known by which vehicles are custom fitted to display advertisement information on their exterior. Such a vehicle is depicted in FIG. 2. In this disclosure, the terms “vehicle” and “car” are used to broadly refer to any type of vehicles, and vehicles used primarily for commercial, public, private or other purposes. In one such method, the vehicle is wrapped with a flexible material printed with graphics. First, using a digital template of the car's exterior, a graphic design is created for an advertisement that will have a suitable appearance on the car. The image is then printed on a suitable material, such as a high quality 3M™ vinyl material, in one or more printed sheets. A solid material is used for the surface of the car and a perforated “one way” material is printed to cover the rear windshield and rear side windows. The printed sheets are then affixed in proper places, overlapping slightly when necessary to cover the surface of the car. The sheet material (such as vinyl) is sufficiently flexible to conform to curved surfaces of the car, such as fenders and doors. The sheet material can also be trimmed as necessary to fit around windows, lights, etc. Using current technology, the graphics will last up to three years in any weather conditions and can be washed normally either by hand or by car washing machines. The wrap (the printed flexible material) may be removed to restore the exterior of the vehicle to normal.

According to embodiments of the present invention, vehicles wrapped with advertisement may be driven by individuals in their normal everyday activities, where the drivers are preferably selected from a database using suitable criteria for the advertising campaign being conducted, or driven by individuals employed to drive the vehicles on designed routes. In addition to driving the vehicles, the drivers preferably perform other advertising activities such as distributing samples and premiums and colleting information.

Optionally, a real-time tracking system using devices such as a GPS may be employed to monitor the locations and travel routes of the vehicles. Based on such information, a measure of impression may be calculated.

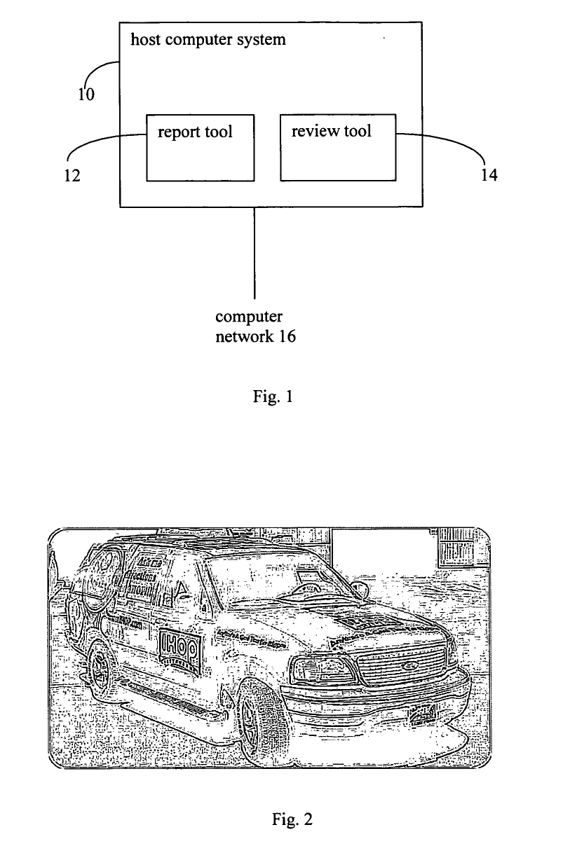

Embodiments of the present invention provide an on-line reporting and proof of performance system that enables timely communication from the drivers to the advertisers. As shown in FIG. 1, a software-based tool (a report tool) 12 is provided which enables the drivers to timely submit reports to a host computer system 10 via a computer network 16. The reports may include text, graphics, images, audio, video or other medium relating to the drivers' advertising activities, as well as feedback and other information collected by the drivers. Another software-based tool (a review tool) 14 is provided which enables the advertisers to review the reports on the host computer system that have been submitted by the drivers. In one embodiment, the reporting and proof of performance system utilizes the Internet for submitting and reviewing the reports. The host computer system, which is connected to the Internet, stores the reports and provides necessary programming to facilitate communication with computers used by the drivers and advertisers. In this instance, the report tool may comprise the necessary programming on the host computer system that facilitates the communication with a computer used by the driver. Likewise, the review tool may comprise the necessary programming on the host computer system that facilitates the communication with a computer used by the advertiser. A link to the host computer (such as an URL), together with account information (such as login id, password), may be sent to the drivers and advertisers to allow them to access protected information on the host computer. Computer networks other than the Internet may be used. The report and review tools may be implemented using techniques well known in the art.

Although a vehicle-based advertising method is described, the on-line reporting system according to embodiments of the present invention is useful in advertising campaigns not employing vehicles. Generally, the on-line reporting system is useful in advertising campaigns that are mobile and experiential.

While the term “advertising” is used in this disclosure, it should be understood broadly to refer to any form of promotion of businesses (products, services, brand name, company image, etc.), political causes, non-profit organizations and causes, etc. Terms commonly used to refer to these activities include advertising, marketing, promotion, etc. The term “advertising” as used in the disclosure and claims should be broadly understood to cover all of the above. Further, terms such as “advertiser” should be broadly understood to refer to the entity on whose behalf the advertising campaign is conducted.

It will be apparent to those skilled in the art that various modification and variations can be made in the advertising method of the present invention without departing from the spirit or scope of the invention. Thus, it is intended that the present invention cover modifications and variations that come within the scope of the appended claims and their equivalents.

What is claimed is:

1. An advertising method comprising:
providing advertisement information or resources to individuals engaged to perform advertising activities;
providing a report tool for the individuals to submit activity reports of advertising activities via a computer network; and
providing a review tool for advertisers to review the submitted activity reports via a computer network.

2. The method of claim 1, wherein the computer network is the Internet.

3. The method of claim 1, wherein the activity reports include text, graphics, images, audio or video relating to the individuals' advertising activities or feedback collected by the individuals.

4. An advertising method comprising:
providing custom-fitted vehicles to individual drivers, the vehicles having been custom fitted to display advertisement information on their exterior;
providing a report tool for individual drivers to submit activity reports of advertising activities via a computer network; and
providing a review tool for advertisers to review the submitted activity reports via a computer network.

5. The method of claim 4, wherein the computer network is the Internet.

6. The method of claim 4, wherein the activity reports include text, graphics, images, audio or video relating to the drivers' advertising activities or feedback collected by the drivers.

7. An advertising method comprising:
providing custom-fitted vehicles to individual drivers, the vehicles having been custom fitted to display advertisement information on their exterior;
the individual drivers performing advertising activities;
the individual drivers submitting activity reports of advertising activities via a computer network; and
the advertisers reviewing the submitted activity reports via a computer network.

8. The method of claim 7, wherein the computer network is the Internet.

9. The method of claim 7, wherein the advertising activities include driving the custom-fitted vehicles and distributing samples or premiums.

10. The method of claim 7, wherein the activity reports include text, graphics, images, audio or video relating to the drivers' advertising activities or feedback collected by the drivers.

11. An advertising method comprising:
providing custom-fitted vehicles to individual drivers, the vehicles having been custom fitted to display advertisement information on their exterior;
automatically obtaining information regarding the locations and travel routes of the vehicles;
calculating impressions generated by each vehicle based on its locations and travel routes;
providing a report tool for individual drivers to submit activity reports of advertising activities via a computer network; and
providing a review tool for advertisers to review the submitted activity reports via a computer network.

12. The method of claim 11, wherein the computer network is the Internet.

13. The method of claim 11, wherein the activity reports include text, graphics, images, audio or video relating to the drivers' advertising activities or feedback collected by the drivers.
